(19) United States
(12) Patent Application Publication
(10) Pub. No.: US 2024/0167410 A1
(43) Pub. Date: May 23, 2024

(54) CATALYTIC ARTICLE COMPRISING VANADIUM-BASED CATALYST AND MOLECULAR SIEVE-BASED CATALYST

(71) Applicant: BASF Corporation, Florham Park, NJ (US)

(72) Inventors: Jiadi Zhang, Shanghai (CN); Yijiang Wu, Shanghai (CN); Liang Chen, Shanghai (CN); Shuxin Lv, Shanghai (CN); Yu Zhang, Shanghai (CN); Edgar Viktor Huennekes, Hannover (DE); Kevin Beard, Iselin, NY (US); Joseph A Patchett, Iselin, NJ (US); Jan Martin Becker, Hannover (DE); Martin Kalwei, Hannover (DE)

(21) Appl. No.: 18/549,242

(22) PCT Filed: Mar. 9, 2022
(86) PCT No.: PCT/CN2022/079948

§ 371 Date: Sep. 6, 2023

(30) Foreign Application Priority Data
Mar. 10, 2021 (WO) PCT/CN2021/080047

(51) Int. Cl. F01N 3/28; B01D 53/94; B01J 23/22; B01J 29/76; B01J 35/00; B01J 35/57; B01J 35/61; B01J 37/02; B01J 37/08; F01N 3/035; F01N 3/10; F01N 3/20

(52) U.S. Cl. CPC F01N 3/2803; B01D 53/9418; B01D 53/9472; B01J 23/22; B01J 29/7615; B01J 35/19; B01J 35/57; B01J 35/617; B01J 37/0228; B01J 37/0236; B01J 37/08; F01N 3/035; F01N 3/101; F01N 3/106; F01N 3/2066; B01D 2255/20723; B01D 2255/20738; B01D 2255/20761; B01D 2255/502; B01D 2255/707; B01D 2255/9035; B01D 2255/9155; B01D 2255/9207; B01D 2257/404; B01D 2258/012; F01N 2370/04

(57) ABSTRACT

The present invention relates to a catalytic article for purifying an exhaust gas containing nitrogen oxides, which comprises a first region containing a vanadium-based SCR catalyst, a second region containing a metal-promoted molecular sieve catalyst, and a third region containing a vanadium-based SCR catalyst, wherein at least part of the second region is located downstream of at least part of the first region and upstream of at least part of the third region in the exhaust gas flow direction, provided that no part of the second region is located upstream of the first region or downstream of the third region. The present invention also relates to a method and a system for treatment of an exhaust gas containing nitrogen oxides by selective catalytic reduction using the catalytic article.

### FIELD OF THE INVENTION

The present invention relates to a catalytic article comprising a vanadium-based catalyst and a metal-promoted molecular sieve catalyst, and a method for treatment of an exhaust gas containing nitrogen oxides by selective catalytic reduction.

### BACKGROUND

Nitrogen oxides (NOx) are common air pollutants, which are generally contained in exhaust gases from mobile sources such as automobiles and stationary sources such as power plants.

Control of NOx emission is always one of the most important topics for example in automobile manufacturing field, due to the environmentally negative impact of NOx on ecosystem, human beings, animals and plants.

Various treatment methods, for example catalytic reduction of nitrogen oxides, have been used to abate NOx in exhaust gases. One typical catalytic reduction process is selective catalytic reduction with ammonia (NH₃) or ammonia precursor as a reducing agent in the presence of atmospheric oxygen, which is also referred to as SCR process. The SCR process is considered superior since a high degree of NOx abatement can be obtained with a small amount of reducing agent. Typically, the nitrogen oxides and the reducing agent NH₃ are reacted in accordance with following equations:

4NO+4NH₃+O₂→4N₂+6H₂O (standard SCR reaction)

2NO₂+4NH₃+O₂→3N₂+6H₂O (slow SCR reaction)

NO+NO₂+2NH₃→2N₂+3H₂O (fast SCR reaction).

A side reaction accompanying the selective catalytic reduction is the formation of low-valent nitrogen oxides, especially nitrous oxide (N₂O) from the reductant NH₃ and oxygen.

The NOx treatment efficacy with respect to for example NOx conversion and N₂O formation greatly depends on the catalyst used in a SCR process. As well known in the art, vanadium-based oxide materials and molecular sieve-based materials are two main types of catalyst useful for the selective catalytic reduction of NOx. Recently, use of the two types of catalysts in combination for the SCR process has attracted more interest.

CN107100700B describes a selective catalytic reduction device including sequentially arranged catalyst units, a first catalyst unit, a second catalyst unit and optionally a third catalyst unit, wherein the first catalyst unit is provided with a zeolite-based catalyst material made of Fe-zeolite or Cu-zeolite, the second catalyst unit is provided with a vanadium-based catalyst material made of oxides of vanadium, titanium and tungsten, and the third catalyst unit is provided with a zeolite-based catalyst material made of Fe-zeolite or Cu-zeolite. It was said it is possible to reduce NOx in the exhaust gas and at the same time minimize the amount of N₂O generated during the process of converting NOx with the plurality of catalyst units arranged in the SCR device.

WO2019/001942A1 describes an exhaust gas aftertreatment device comprising a first SCR catalyst which includes a copper-containing zeolite material, an ammonia slip catalyst arranged downstream of the first SCR catalyst, a particulate filter, a second SCR catalyst having a vanadium-containing SCR material arranged upstream of the first SCR catalyst, an oxidation catalyst arranged downstream of the ammonia slip catalyst and upstream of the particulate filter, and a layer of zeolite material containing copper applied onto a surface of the ammonia slip catalyst having at least one noble metal.

WO2018/115045A1 describes a catalyst device for purifying exhaust gases containing nitrogen oxides by means of selective catalytic reduction (SCR), which comprises at least two catalytic regions, the first region containing vanadium oxide and cerium oxide, and the second region containing an iron-containing molecular sieve. It was said that the efficiency of the SCR can be significantly improved and the formation of N₂O is significantly suppressed by combining vanadium oxide with cerium oxide in a catalyst device which also has a catalytic region with an iron-containing molecular sieve.

The NOx treatment efficiency of SCR catalysts under some particular operation conditions is still in need of improvement. The inventors found that frequent temperature ramp up and ramp down periods may occur during the operation of some models of vehicles, along with insufficient NH₃ dosing and/or higher NO₂/NOx ratio than 50% at the inlet of the SCR catalysts. The fluctuation of conditions may lead to a negative impact on NOx conversion, that is a non-ignorable problem in the treatment of automotive exhaust gases.

It will be desirable if an SCR catalyst having improved NOx abatement efficiency under fluctuation of conditions could be developed.

### SUMMARY OF THE INVENTION

It is an object of the present invention to provide a catalytic article which performs well under fluctuation of conditions during the operation of some models of vehicles, including for example temperature ramp, exhaust gas space velocity, NH₃ dosing, and NO₂/NOx ratio at the inlet of the SCR catalyst.

It has surprisingly been found that the object was achieved by a catalytic article which comprises a region of metal-promoted molecular sieve catalyst and two regions of vanadium-based SCR catalyst.

Accordingly, in one aspect, the present invention relates to a catalytic article for purifying an exhaust gas containing nitrogen oxides, which comprises
a first region containing a vanadium-based SCR catalyst,
a second region containing a metal-promoted molecular sieve catalyst, and
a third region containing a vanadium-based SCR catalyst,

wherein
at least part of the second region is located downstream of at least part of the first region and upstream of at least part of the third region in the exhaust gas flow direction,
provided that no part of the second region is located upstream of the first region or downstream of the third region.

In another aspect, the present invention relates to a method for treatment of an exhaust gas containing nitrogen oxides by selective catalytic reduction, which comprises contacting the exhaust gas with the catalytic article as described herein in the presence of a reductant.

In a further aspect, the present invention relates to a system for treatment of an exhaust gas, especially from an internal combustion engine, which comprises a reductant source, the catalytic article as described herein, and optionally one or more of diesel oxidation catalyst (DOC), three-way conversion catalyst (TWC), four-way conversion catalyst (FWC), non-catalyzed or catalyzed soot filter (CSF), ammonia oxidation catalyst (AMOx), NOx trap, NOx absorber catalyst, hydrocarbon trap catalyst, sensor and mixer.

It has been found by the inventors that the catalytic article according to the present invention is particularly useful for abatement of NOx in an exhaust gas from an automobile engine, in which treatment condition fluctuations will be encountered.

### BRIEF DESCRIPTION OF THE DRAWINGS

FIG. 1 schematically shows the periodic condition changes for test of the SCR performance according to Example 9.1.

FIG. 2 schematically shows the periodic condition changes for test of the SCR performance according to Example 9.2.

### DETAILED DESCRIPTION OF THE INVENTION

The present invention will be described in detail hereinafter. It is to be understood that the present invention may be embodied in many different ways and shall not be construed as limited to the embodiments set forth herein.

Herein, the singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

The term “catalytic article” as used herein is just intended to mean an item in a certain shape having the function of catalyst, which is not necessarily a single body. In other words, the catalytic article may be a single body or consist of two or more separatable bodies.

The term “region” as used herein is just intended to mean each of the catalysts as specified, either present in washcoat or extrudate, extends a certain length in the exhaust gas flow direction. The terms “first region”, “second region” and “third region” by themselves are not intended to indicate the regions are immediately adjacent to each other or in any other particular spatial arrangements.

According to the first aspect, the present invention provides a catalytic article for purifying an exhaust gas containing nitrogen oxides, which comprises
a first region containing a vanadium-based SCR catalyst,
a second region containing a metal-promoted molecular sieve catalyst, and
a third region containing a vanadium-based SCR catalyst,

wherein
at least part of the second region is located downstream of at least part of the first region and upstream of at least part of the third region in the exhaust gas flow direction,
provided that no part of the second region is located upstream of the first region or downstream of the third region.

Particularly, the present invention provides a catalytic article for purifying an exhaust gas containing nitrogen oxides, which comprises
a first region containing a vanadium-based SCR catalyst,
a second region containing a metal-promoted molecular sieve catalyst, and
a third region containing a vanadium-based SCR catalyst,

wherein the second region is located downstream of at least part of the first region and upstream of at least part of the third region.

More particularly, the present invention provides a catalytic article for purifying an exhaust gas containing nitrogen oxides, which comprises
a first region containing a vanadium-based SCR catalyst,
a second region containing a metal-promoted molecular sieve catalyst, and
a third region containing a vanadium-based SCR catalyst,

wherein the second region is located totally downstream of the first region and totally upstream of the third region.

The first region contains vanadium-based SCR catalyst. The vanadium-based SCR catalyst refers to any materials containing vanadium, typically in form of oxides as a main active species for selective catalytic reduction of NOx. The materials containing vanadium useful for selective catalytic reduction of NOx are well known in the art. There is no particular restriction to the vanadium-based SCR catalysts useful for the first region and the third region.

The vanadium-based SCR catalyst generally contains or consists of a vanadium oxide (e.g., V₂O₅) as the main active species and optionally at least one oxide of other metal (or element) as a promoter, which are supported on particles of support.

The metals (or elements) useful as the promoter may include but are not limited to boron (B), aluminum (Al), bismuth (Bi), silicon (Si), tin (Sn), lead (Pb), antimony (Sb), chromium (Cr), manganese (Mn), iron (Fe), cobalt (Co), nickel (Ni), copper (Cu), zinc (Zn), gallium (Ga), cerium (Ce), yttrium (Y), niobium (Nb), molybdenum (Mo) and tungsten (W). Particularly, the vanadium-based SCR catalyst contains a vanadium oxide and optionally at least one oxide of the element selected from silicon (Si), antimony (Sb), molybdenum (Mo) and tungsten (W).

In some embodiments according to the present invention, the vanadium-based SCR catalyst contains or consists of a vanadium oxide and at least one oxide of the element selected from silicon (Si), antimony (Sb), molybdenum (Mo) and tungsten (W) on particles of support. For example, the vanadium-based SCR catalyst contains or consists of oxides of V, Sb and Si on particles of support.

It will be understood that the vanadium oxide and, when present, the at least one oxide of other metal (or element) may be present in form of respective oxides, or a composite oxide of vanadium and the other metal (or element), or a combination thereof.

Useful materials as the support may include, but are not limited to molecular sieve and one or more oxides of a metal selected from the group consisting of Ti, Si, W, Al, Ce, Zr, Mg, Ca, Ba, Y, La, Pr, Nb, Mo, Mn, Fe, Co, Ni, Cu, Zn, Ga, Sn and Bi. Preferably, the the support may be one or more selected from titania (preferably species containing anatase form), silica, alumina, zirconia, and any dopant-stabilized forms thereof.

The support may be contained in the vanadium-based SCR catalyst in each of the first and third regions in an amount of at least 40% by weight, at least 50% by weight, or at least 60% by weight, for example at least 65% by weight, at least 70% by weight and at least 75% by weight, based on the total weight of the vanadium-based SCR catalyst. The amount of the support may be up to 95% by weight, up to 90% by weight or up to 80% by weight, based on the total weight of the vanadium-based SCR catalyst.

The vanadium-based SCR catalyst in each of the first and third regions may contain vanadium, calculated as V₂O₅, in an amount of 0.1 to 20% by weight, 1 to 15% by weight, 2 to 10% by weight, or 2 to 7% by weight, based on the total weight of the vanadium-based SCR catalyst. It will be understood that the vanadium contents of the vanadium-based SCR catalysts in the two regions may be same or different.

Each of the at least one oxide of other metal (or element) as a promoter, when present, may be contained in the vanadium-based SCR catalyst in each of the first and third regions in an amount of 0.1 to 30% by weight, 1 to 15% by weight, or 2 to 8% by weight, based on the total weight of the vanadium-based SCR catalyst.

In some illustrative embodiments, the vanadium-based SCR catalyst in each of the first and third regions contains or consists of:
(a) 1 to 15% by weight of a vanadium oxide, calculated as V₂O₅.
(b) 1 to 25% by weight an antimony oxide, calculated as Sb₂O₃,
(c) 1 to 10% by weight of SiO₂,
(d) optionally 1 to 10% by weight of a tungsten oxide, calculated as WO₃,
(e) 65 to 95% by weight of TiO₂ support,

each being based on the total weight of the vanadium-based SCR catalyst.

In some illustrative embodiments, the vanadium-based SCR catalyst contains or consists of:
(a) 2 to 10% by weight of a vanadium oxide, calculated as V₂O₅.
(b) 1 to 15% by weight an antimony oxide, calculated as Sb₂O₃,
(c) 2 to 10% by weight of SiO₂,
(d) optionally, 2 to 8% by weight of a tungsten oxide, calculated as WO₃,
(e) 70 to 90% by weight of TiO₂ support,

each being based on the total weight of the vanadium-based SCR catalyst.

In some further illustrative embodiments, the vanadium-based SCR catalyst consists of:
(a) 2 to 7% by weight of a vanadium oxide, calculated as V₂O₅,
(b) 2 to 8% by weight an antimony oxide, calculated as Sb₂O₃,
(c) 2 to 8% by weight of SiO₂,
(e) 80 to 90% by weight of TiO₂ support,

each being based on the total weight of the vanadium-based SCR catalyst.

The total weight of the vanadium-based SCR catalyst in each case as described herein will be 100% by weight.

The vanadium-based SCR catalysts in the first region and the third region may be same or different with respect to the composition. It will be understood that the vanadium-based SCR catalysts in the first and third regions may differ from each other in the active compositions, in the species and/or particle size characteristics of the support, or in any other aspects.

In some embodiments according to the present invention, the vanadium-based SCR catalysts in the first region and the third region are same.

The first and third regions, independently from each, may also contain other components in addition to the vanadium-based SCR catalyst, which may be non-catalytically active components, for example processing aids useful in the preparation of a catalytic article such as lubricants and binders. The other components may also be catalytically active, for example active species other than the vanadium-based SCR catalyst and the metal-promoted molecular sieve catalyst as described herein.

The second region contains a metal-promoted molecular sieve catalyst. As used herein, “metal-promoted molecular sieve catalyst” is intended to mean the metal-promoted molecular sieve has the SCR activity as required for abatement of NOx.

Molecular sieves refer to framework materials based on an extensive three-dimensional network of oxygen ions containing generally tetrahedral type sites and having a substantially uniform pore distribution. Suitable molecular sieves for the purpose of the present invention may be microporous or mesoporous. Typically, molecular sieves having an average pore size of less than 2 nm is classed as “microporous”, and molecular sieves having an average pore size of 2 to 50 nm is classed as “mesoporous”. The pore sizes are defined by the ring size.

Particularly, the molecular sieve is a zeolite. The term “zeolite” has its usual meaning in the art and typically refers to a crystalline material (typically aluminosilicate) having a spatial network structure with open 3-dimensional framework structures composed of corner-sharing TO₄ tetrahedra, where T is tetravalent element (typically Si) or trivalent element (typically Al). Cations that balance the charge of the anionic framework are loosely associated with the framework oxygens, and the remaining pore volume is filled with water molecules. The non-framework cations are generally exchangeable, and the water molecules removable.

For the purpose of the present invention, suitable molecular sieves may include, but are not limited to zeolites having a framework type selected from the group consisting of ABW, ACO, AEI, AEL, AEN, AET, AFG, AFI, AFN, AFO, AFR, AFS, AFT, AFV, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEI, EMT, EON, EPI, ERI, ESV, ETR, EUO, *-EWT, EZT, FAR, FAU, FER, FRA, GIS, GIU, GME, GON, GOO, HEU, IFO, IFR, -IFU, IFW, IFY, IHW, IMF, IRN, IRR, -IRY, ISV, ITE, ITG, ITH, *-ITN, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, *MRE, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POS, PSI, PUN, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, *SFV, SFW, SGT, SIV, SOD, SOF, SOS, SSF, *-SSO, SSY, STF, STI, *STO, STT, STW, -SVR, SVV, SZR, TER, THO, TOL, TON, TSC, TUN, UEI, UFI, UOS, UOV, UOZ, USI, UTL, UWY, VET, VFI, VNI, VSV, WEI, -WEN, YUG and ZON, and any combinations thereof.

Particularly, the molecular sieves useful for the second region include zeolites having a framework type selected from the group AEI, AEL, AFI, AFT, AFO, AFX, AFR, ATO, BEA, CHA, DDR, EAB, EMT, ERI, EUO, FAU, FER, GME, HEU, JSR, KFI, LEV, LTA, LTL, LTN, MAZ, MEL, MFI, MOR, MOZ, MSO, MTW, MWW, OFF, RTH, SAS, SAT, SAV, SBS, SBT, SFW, SSF, SZR, TON, TSC and WEN.

In some embodiments, the molecular sieves useful for the second region include zeolites having a framework type selected from the group AEI, BEA (e.g. beta), CHA (e.g. chabazite, SSZ-13), AFT, AFX, FAU (e.g. zeolite Y), MOR, MFI (e.g. ZSM-5), MOR (e.g. mordenite) and MEL, among which AEI, BEA and CHA are particularly preferred.

In some other embodiments, the molecular sieves useful for the second region may be selected from small pore zeolites. The term “small pore zeolites” refers to zeolites having pore openings which are smaller than about 5 Angstroms (Å). The small pore zeolites may be small pore 8-ring zeolites. The term “8-ring zeolite” refers to a zeolite having 8-ring pore openings. Some 8-ring zeolites may have double-six ring (d6r) secondary building units in which a cage like structure is formed resulting from the connection of double six-ring building units by 4-rings. Exemplary small pore 8-ring zeolites include framework types AEI, AFT, AFX, CHA, EAB, EMT, ERI, FAU, GME, JSR, KFI, LEV, LTL, LTN, MOZ, MSO, MWW, OFF, SAS, SAT, SAV, SBS, SBT, SFW, SSF, SZR, TSC and WEN.

In some particular embodiments, the small pore zeolites useful for the second region include zeolites having a framework type selected from the group consisting of AEI, AFT, AFX, CHA, EAB, ERI, KFI, LEV, SAS, SAT and SAV. The small pore zeolites having a framework type selected from the group consisting of AEI, AFT, AFX and CHA may be particularly mentioned.

It will be appreciated that when a zeolite is mentioned by reference to the framework type code as generally accepted by the International Zeolite Association (IZA) herein, it is intended to include not only the reference material but also any isotypic framework materials having SCR catalytic activities. The list of reference material and the isotypic framework materials for each framework type code are available from the database of IZA (http://www.iza-structure.org/databases).

The zeolites useful as the molecular sieve in the metal-promoted molecular sieve catalyst, for example those having any of the framework types as described hereinabove, suitably have a SiO₂/Al₂O₃ molar ratio (SAR) in the range of 5:1 to 150:1, preferably 5:1 to 50:1, and particularly 10:1 to 30:1.

The molecular sieves may exhibit a high surface area, for example a BET surface area, of at least 300 m²/g, at least 400 m²/g, at least 550 m²/g or at least 650 m²/g, for example 400 to 750 m²/g or 500 to 750 m²/g, as determined according to DIN 66131. Alternatively or additionally, the molecular sieves may have a mean crystal size of 10 nanometers to 10 microns, 50 nanometers to 5 microns, 0.1 to 2 microns, or 0.1 to 0.5 microns as determined via SEM.

The molecular sieve in the second region is metal-promoted, which means a metal capable of improving the catalytic activity of the molecular sieve has been incorporated into and/or onto the molecular sieve. The metal, also referred to as a promoter metal, is present in the molecular sieve as a non-framework element. In other words, the promoter metal does not participate in constituting the molecular sieve framework. The promoter metal may reside within the molecular sieve and/or on at least a portion of the molecular sieve surface, preferably in form of ionic species.

The promoter metal may be any metals known useful for improving the catalytic performance of zeolites in the application of selective catalytic reduction (SCR) of NOx. Generally, the promoter metal may be selected from precious metals such as Au and Ag, platinum group metals such as Ru, Rh, Pd, In and Pt, base metals such as Cr, Zr, Nb, Mo, Fe, Mn, W, V, Ti, Co, Ni, Cu, Zn, Sb, Sn and Bi, alkali earth metals such as Ca and Mg, and any combinations thereof. The promoter metal is preferably Fe or Cu or a combination thereof.

In some illustrative embodiments, the metal-promoted molecular sieve catalyst useful for the second zone is a Cu and/or Fe promoted zeolite having the framework type of AEI, BEA, CHA, AFT, AFX, FAU, FER, KFI, MOR, MFI, MOR or MEL. In some further illustrative embodiments, the metal-promoted molecular sieve catalyst is a Cu and/or Fe promoted zeolite having the framework of AEI, BEA or CHA.

The promoter metal may be present in the metal-promoted molecular sieve catalyst at an amount in the range of 0.1 to 20% by weight, 0.5 to 15% by weight, 1 to 10% by weight or 4 to 10% by weight on an oxide basis, based on the total weight of the metal-promoted molecular sieve. In some illustrative embodiments wherein Cu or Fe is used as the promoter metal, the promoter metal is preferably present at an amount of 0.5 to 15% by weight, or 1 to 15% by weight, or 1 to 10% by weight, on an oxide basis, based on the total weight of the metal-promoted molecular sieve.

The second region may contain one or more metal-promoted molecular sieve catalysts. In other words, just one metal-promoted molecular sieve catalyst or a combination of two or more metal-promoted molecular sieve catalysts may be used for the second region.

The second region may also contain other components in addition to the metal-promoted molecular sieve catalyst, particularly non-catalytically active components, for example processing aids such as binders useful in the preparation of a catalytic article.

The first region containing a vanadium-based catalyst, the second region containing a metal-promoted molecular sieve catalyst, and the third region containing a vanadium-based SCR catalyst may, independently from each other, be present in the SCR catalytic article according to the present invention in form of an extrudate or in form of a washcoat on a substrate.

The term “extrudate” generally refers to shaped bodies formed by extrusion. The extrudate may have any suitable structures allowing exhaust gas flow through, preferably honeycomb structure. The honeycomb structure may have flow passages as described for the monolithic flow-through and wall-flow structures hereinbelow. When any of the first, second and third regions is present in form of an extrudate, the extrudate may be formed from respective catalyst and optionally at least one processing aids such as binders and lubricants, by any conventional means.

The term “substrate” generally refers to a structure that is suitable for withstanding conditions encountered in exhaust streams, on which a catalytic material is carried, typically in the form of a washcoat.

Typically, the substrate may be a monolithic flow-through structure, which has a plurality of fine, parallel gas flow passages extending from an inlet to an outlet face of the substrate such that passages are open to fluid flow therethrough. The passages, which are essentially straight paths from their fluid inlet to their fluid outlet, are defined by walls on which the catalytic material is applied as washcoats so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures may contain 60 to 900 or more flow passages (or “cells”) per square inch of cross section. For example, the substrate may have 50 to 600 cells per square inch (“cpsi”) or 200 to 450 cpsi. The wall thickness of flow-through substrates may vary, with a typical range from 2 mils to 0.1 inches.

The substrate may also a monolithic wall-flow structure having a plurality of fine, parallel gas flow passages extending along from an inlet to an outlet face of the substrate wherein alternate passages are blocked at opposite ends. The passages are defined by walls on which the catalytic material is applied as washcoats so that the gases flowing through the passages contact the catalytic material. The configuration requires the gases flow through the porous walls of the wall-flow substrate to reach the outlet face. The wall-flow substrates may have up to 700 cpsi, for example 100 to 400 cpsi. The flow passages of the monolithic substrate are thin-walled channels, which can be of any suitable cross-sectional shape and size such as trapezoidal, rectangular, square, sinusoidal, hexagonal, oval, circular, etc. The wall thickness of wall-flow substrates may vary, with a typical range from 2 mils to 0.1 inches.

The term “washcoat” has its usual meaning in the art and refers to a thin, adherent coating of a catalytic or other material applied to a substrate. A washcoat is generally formed by preparing a slurry containing the desired material and optionally processing aids such as binder with a certain solid content (e.g., 15-60% by weight) and then applying the slurry onto a substrate, dried and calcined to provide a washcoat layer. The washcoat is generally loaded on the substrate in an amount of 0.5 to 10 g/in³, preferably 1 to 7 g/in³.

The substrate is usually inert and conventionally made of, for example, ceramic or metal materials, which will be referred to as “inert substrate” herein. It can be contemplated that the substrate may alternatively be active. In that case the substrate may consist of, for example, extrudate containing the vanadium-based catalyst, the metal-promoted molecular sieve catalyst or other catalytically active species. For example, any of the first, second and third regions may be present in form of an extrudate which constitutes the substrate of any of the other regions in form of washcoat.

In some illustrative embodiments of the SCR catalytic article according to the present invention, the first region containing a vanadium-based catalyst, the second region containing a metal-promoted molecular sieve catalyst, and the third region containing a vanadium-based SCR catalyst are present as washcoats on one or more pieces of inert substrate.

In some particular illustrative embodiments, the first, second and third regions are carried on two or more pieces of inert substrate separately. For example, the first, second and third regions may be carried on exactly two or three pieces of inert substrate separately. When two or more pieces of inert substrate are used, the pieces of substrate may be made of same or different materials.

In case of two pieces of inert substrate being used, the first and second regions or the second and the third regions are carried on one piece of substrate and the remaining region is carried on the other piece of substrate, or the first and part of the second region are carried on one piece of substrate, and the remaining second region and the third region are carried on the other piece of substrate. The two regions on the same one piece of substrate may be applied on the substrate by washcoating respective slurries sequentially. In this case, the two regions on the same one piece of substrate may be arranged adjacent to or overlapping each other.

In some other illustrative embodiments of the SCR catalytic article according to the present invention, the first region containing a vanadium-based catalyst is present as an extrudate, the second region containing a metal-promoted molecular sieve catalyst and the third region containing a vanadium-based SCR catalyst are present as washcoats on one or more pieces of inert substrate. Alternatively, the first region and the second region are present as washcoats on one or more pieces of inert substrate, and the third region is present as an extrudate.

In some further illustrative embodiments of the SCR catalytic article according to the present invention, the first region is present as an extrudate, and the second region is present on the extrudate as a washcoat extending from the outlet side of the extrudate to the inlet side with a length less than the full length of the extrudate, ant the third region is present as a washcoat on a piece of inert substrate or present as a separate extrudate.

Alternatively, the third region is present as an extrudate, and the second region is present on the extrudate as a washcoat extending from the inlet side of the extrudate to the outlet side with a length less than the full length of the extrudate, ant the first region is present as a washcoat on a piece of inert substrate or present as a separate extrudate.

Alternatively, the first and third region both are present as extrudates, and the second region is present on the extrudate of first region as a washcoat extending from the outlet side of the extrudate to the inlet side with a length less than the full length of the extrudate, and/or on the extrudate of third region as a washcoat extending from the inlet side of the extrudate to the outlet side with a length less than the full length of the extrudate of the third region.

As used herein, “a length less than the full length of the extrudate” refers to no more than 90%, for example no more than 80%, no more than 70%, no more than 60%, no more than 50%, no more than 40%, no more than 30% of the full length of the extrudate.

The first region, the second region and the third region each may be comprised in the SCR catalytic article according to the present invention in any suitable proportions in the range of 0.5 to 90% by volume, relative to the total volume of the catalytic article.

In some embodiments, the second region containing a metal-promoted molecular sieve catalyst may be comprised in the SCR catalytic article according to the present invention in a proportion of 0.5 to 80% by volume, preferably 1 to 75% by volume, more preferably 5 to 65% by volume, for example 10 to 60% by volume or 15 to 50% by volume, relative to the total volume of the catalytic article.

The first and third regions containing a vanadium-based SCR catalyst may, independently from each other, be comprised in the SCR catalytic article according to the present invention in a proportion of 10 to 60% by volume, preferably 15 to 55% by volume, more preferably 25 to 50% by volume, relative to the total volume of the catalytic article.

In some illustrative embodiments, the SCR catalytic article according to the present invention comprises
10 to 60% by volume of a first region containing a vanadium-based SCR catalyst,
5 to 65% by volume of a second region containing a metal-promoted molecular sieve catalyst, and
10 to 60% by volume of a third region containing a vanadium-based SCR catalyst, each being relative to the total volume of the catalytic article.

In some other illustrative embodiments, the SCR catalytic article according to the present invention comprises
15 to 55% by volume of a first region containing a vanadium-based SCR catalyst,
10 to 60% by volume of a second region containing a metal-promoted molecular sieve catalyst, and
15 to 55% by volume of a third region containing a vanadium-based SCR catalyst, each being relative to the total volume of the catalytic article.

In further illustrative embodiments, the SCR catalytic article according to the present invention comprises
25 to 50% by volume of a first region containing a vanadium-based SCR catalyst,
15 to 50% by volume of a second region containing a metal-promoted molecular sieve catalyst, and
25 to 50% by volume of a third region containing a vanadium-based SCR catalyst, each being relative to the total volume of the catalytic article.

The proportion by volume as mentioned for a region refers to the spatial volume the region occupies. It will be appreciated that if a region is present as a washcoat on a substrate, the proportion by volume of the region is intended to refer to the volume of the part of the substrate on which the region is located.

The catalytic article according to the present invention may comprise one or more further components having any function other than SCR, including but being not limited to oxidation function and storage function. The one or more further components may be arranged together with any of the three regions. For example, an oxidation catalyst based on platinum group metal (PGM) may be located in the area of the first region to oxidize hydrocarbon, CO or NO, or in the area of the third region to oxidize NH₃. It can also be contemplated that a storage component such as hydrocarbon adsorber and NOx adsorber may be arranged in the area of the first region. The one or more further components may be present in any forms, for example washcoat or co-extrudate.

The SCR catalytic article according to the present invention may be used to treat exhaust gases from for example stationary combustion devices such as power plants and heating systems for buildings and private households, and mobile combustion devices such as combustion engines of vehicles, especially diesel engines. The SCR catalytic article according to the present invention may particularly effective to treat exhaust gases from internal combustion engines, for example gasoline or diesel engines, especially heavy-duty diesel engines.

Accordingly, in another aspect, the present invention relates to a method for treatment of an exhaust gas containing nitrogen oxides by selective catalytic reduction, which comprises contacting the exhaust gas with the SCR catalytic article as described herein in the presence of a reductant.

In some embodiments, the method is useful for treatment of an exhaust gas originating from internal combustion engines, for example gasoline or diesel engines, especially heavy-duty diesel engines.

In a further aspect, the present invention relates to a system for treatment of an exhaust gas, especially from an internal combustion engine, which comprises a reductant source and the catalytic article as described herein.

The system for treatment of an exhaust gas may further comprise one or more exhaust gas treatment elements. Conventional exhaust gas treatment elements include, but are not limited to catalyst other than SCR catalyst, such as diesel oxidation catalyst (DOC), three-way conversion catalyst (TWC), four-way conversion catalyst (FWC), non-catalyzed or catalyzed soot filter (CSF), ammonia oxidation catalyst (AMOx), NOx trap, NOx absorber catalyst, hydrocarbon trap catalyst, sensor and mixer.

In a variant of the system for treatment of an exhaust gas, at least one region of the catalytic article is not closely connected to the other region(s). In this case, one or more elements of the exhaust gas treatment system may be arranged intermediately, for example a catalytic component other than SCR catalyst, reductant source, filter, sensor and mixer.

It is preferred that the exhaust gas treatment system further comprise a diesel oxidation catalyst located downstream of the engine and upstream of the SCR catalytic article according to the present invention. In some embodiments, the exhaust gas treatment system preferably comprises both a diesel oxidation catalyst and a catalyzed soot filter located upstream of the SCR catalytic article according to the present invention.

### Embodiments

Various embodiments are listed below. It will be understood that the embodiments listed below may be combined with all aspects and other embodiments in accordance with the scope of the invention.

Embodiment 1. A catalytic article for purifying an exhaust gas containing nitrogen oxides, which comprises
a first region containing a vanadium-based SCR catalyst,
a second region containing a metal-promoted molecular sieve catalyst, and
a third region containing a vanadium-based SCR catalyst,

wherein
at least part of the second region is located downstream of at least part of the first region and upstream of at least part of the third region in the exhaust gas flow direction, provided that no part of the second region is located upstream of the first region or downstream of the third region.

Embodiment 2. The catalytic article according to preceding embodiment, wherein the vanadium-based SCR catalyst in each of the first region and the third region contains a vanadium oxide and optionally at least one oxide of other element as a promoter, which are supported on particles of support.

Embodiment 3. The catalytic article according to preceding embodiment, wherein the other element as a promoter is selected from B, Al, Bi, Si, Sn, Pb, Sb, Cr, Mn, Fe, Co, Ni, Cu, Zn, Ga, Ce, Y, Nb, Mo and W.

Embodiment 4. The catalytic article according to preceding embodiment 2 or 3, wherein the support is selected from molecular sieve and one or more oxides of an element selected from Ti, Si, W, Al, Ce, Zr, Mg, Ca, Ba, Y, La, Pr, Nb, Mo, Mn, Fe, Co, Ni, Cu, Zn, Ga, Sn and Bi.

Embodiment 5. The catalytic article according to any of preceding embodiments, wherein the vanadium-based SCR catalysts in the first region and the third region contain vanadium, calculated as V₂O₅, in an amount of 0.1 to 20% by weight, 1 to 15% by weight, 2 to 10% by weight, or 2 to 7% by weight, based on the total weight of the vanadium-based SCR catalyst, and wherein the vanadium contents of the vanadium-based SCR catalysts in the two regions are same or different.

Embodiment 6. The catalytic article according to any of preceding embodiments, wherein the molecular sieve in the metal-promoted molecular sieve catalyst is selected from zeolites having a framework type of ABW, ACO, AEI, AEL, AEN, AET, AFG, AFI, AFN, AFO, AFR, AFS, AFT, AFV, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEI, EMT, EON, EPI, ERI, ESV, ETR, EUO, *-EWT, EZT, FAR, FAU, FER, FRA, GIS, GIU, GME, GON, GOO, HEU, IFO, IFR, -IFU, IFW, IFY, IHW, IMF, IRN, IRR, -IRY, ISV, ITE, ITG, ITH, *-ITN, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, *MRE, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POS, PSI, PUN, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, *SFV, SFW, SGT, SIV, SOD, SOF, SOS, SSF, *-SSO, SSY, STF, STI, *STO, STT, STW, -SVR, SVV, SZR, TER, THO, TOL, TON, TSC, TUN, UEI, UFI, UOS, UOV, UOZ, USI, UTL, UWY, VET, VFI, VNI, VSV, WEI, -WEN or YUG, ZON, and any combinations thereof.

Embodiment 7. The catalytic article according to any of preceding embodiments, wherein the molecular sieve in the metal-promoted molecular sieve catalyst is selected from zeolites having a framework type of AEI, AEL, AFI, AFT, AFO, AFX, AFR, ATO, BEA, CHA, DDR, EAB, EMT, ERI, EUO, FAU, FER, GME, HEU, JSR, KFI, LEV, LTA, LTL, LTN, MAZ, MEL, MFI, MOR, MOZ, MSO, MTW, MWW, OFF, RTH, SAS, SAT, SAV, SBS, SBT, SFW, SSF, SZR, TON, TSC or WEN.

Embodiment 8. The catalytic article according to any of preceding embodiments, wherein the molecular sieve in the metal-promoted molecular sieve catalyst is selected from zeolites having a framework type of AEI, BEA, CHA, AFT, AFX, FAU, FER, KFI, MOR, MFI, MOR or MEL, among which AEI, BEA and CHA are particularly preferred.

Embodiment 9. The catalytic article according to any of preceding embodiments, wherein the metal for promoting the molecular sieve in the second region is selected from precious metals such as Au and Ag, platinum group metals such as Ru, Rh, Pd, In and Pt, base metals such as Cr, Zr, Nb, Mo, Fe, Mn, W, V, Ti, Co, Ni, Cu, Zn, Sb, Sn and Bi, alkali earth metals such as Ca and Mg, and any combinations thereof.

Embodiment 10. The catalytic article according to any of preceding embodiments, wherein the metal for promoting the molecular sieve in the second region is Fe, Cu or a combination thereof.

Embodiment 11. The catalytic article according to any of preceding embodiments, wherein the metal for promoting the molecular sieve in the second region is present in the metal-promoted molecular sieve catalyst at an amount of in the range of 0.1 to 20% by weight, 0.5 to 15% by weight or 1 to 10% by weight on an oxide basis, based on the total weight of the metal-promoted molecular sieve.

Embodiment 12. The catalytic article according to any of preceding embodiments, wherein the first region, the second region and the third region are, independently from each other, present in form of an extrudate or in form of a washcoat on a substrate.

Embodiment 13. The catalytic article according to preceding embodiment, wherein the extrudate and/or the substrate have a honeycomb structure, for example monolithic flow-through structure or wall-flow structure.

Embodiment 14. The catalytic article according to any of preceding embodiments, wherein the first, second and third regions are carried on two or more pieces of inert substrate separately, preferably two or three pieces of inert substrate separately.

Embodiment 15. The catalytic article according to any of preceding embodiments, wherein the second region is comprised in the catalytic article in a proportion of 0.5 to 80% by volume, preferably 1 to 75% by volume, more preferably 5 to 65% by volume, for example 10 to 60% by volume or 15 to 50% by volume, relative to the total volume of the catalytic article.

Embodiment 16. The catalytic article according to any of preceding embodiments, wherein the first and third regions are, independently from each other, comprised in the catalytic article in a proportion of 10 to 60% by volume, preferably 15 to 55% by volume, more preferably 25 to 50% by volume, relative to the total volume of the catalytic article.

Embodiment 17. The catalytic article according to any of preceding embodiments, which comprises
a first region containing a vanadium-based SCR catalyst,
a second region containing a metal-promoted molecular sieve catalyst, and
a third region containing a vanadium-based SCR catalyst,

wherein the second region is located downstream of at least part of the first region and upstream of at least part of the third region.

Embodiment 18. The catalytic article according to any of preceding embodiments, which comprises
a first region containing a vanadium-based SCR catalyst,
a second region containing a metal-promoted molecular sieve catalyst, and
a third region containing a vanadium-based SCR catalyst,

wherein the second region is located totally downstream of the first region and totally upstream of the third region.

Embodiment 19. A method for treatment of an exhaust gas containing nitrogen oxides, which comprises contacting the exhaust gas with the catalytic article as defined in any of embodiments 1 to 18 in the presence of a reductant.

Embodiment 20. The method according to embodiment 19, wherein the exhaust gas originates from internal combustion engines, for example gasoline or diesel engines, especially heavy-duty diesel engines.

Embodiment 21. A system for treatment of an exhaust gas, especially originating from an internal combustion engine, which comprises a reductant source, the catalytic article according to any of embodiments 1 to 20, and optionally one or more of diesel oxidation catalyst (DOC), three-way conversion catalyst (TWC), four-way conversion catalyst (FWC), non-catalyzed or catalyzed soot filter (CSF), ammonia oxidation catalyst (AMOx), NOx trap, NOx absorber catalyst, hydrocarbon trap catalyst, sensor and mixer.

The invention will be further illustrated by following Examples, which set forth particularly advantageous embodiments. While the Examples are provided to illustrate the present invention, they are not intended to limit it.

### EXAMPLES

### Example 1 Catalytic Article Sample with the Catalyst Arrangement of V—Fe—V

1.1 Preparation of a Brick Comprising V-Based SCR Catalyst on Substrate (V-SCR Brick)

173.2 g TiO₂ in anatase form having a titanium content of 95.9 wt % calculated as TiO₂, 74.4 g vanadyl oxalate solution having a vanadium content of 10.75 wt % calculated as V₂O₅ and 12.0 g Sb₂O₃ were mixed in 200 g DI water at room temperature. After stirring the obtained suspension for 30 minutes, 30% aqueous ammonia solution was further added to raise the system pH to 7.0. Then 46.2 g SiO₂ sol with 30.1 wt % SiO₂ content was added. After stirring for 1 hour, a homogenous slurry was obtained. A flow-through honeycomb cordierite substrate of 300 cpsi with a wall thickness of 5 mils was dipped into the obtained slurry to load enough slurry. Extra loaded slurry was blown off with an air knife carefully, followed by drying with hot air at 150° C. for 15 minutes and then calcining at 450° C. for 1 hour in air.

The process of dipping, drying and calcining was repeated until a total washcoat loading on the substrate of 4.5 g/in³ was obtained. The V-based SCR catalyst has a vanadium content of 4.0 wt %, calculated as V₂O₅.

1.2 Preparation of a Brick Comprising Fe-Promoted Molecular Sieve on Substrate (Fe-Zeolite Brick)

A Fe/Beta zeolite from Zeolyst was used, which has a SiO₂ to Al₂O₃ molar ratio of 9, an iron loading of 4.8 wt % calculated as Fe₂O₃, X-ray crystallinity of 98%, BET surface area of 578 m²/g, D₉₀=13 microns, Na₂O of 0.07 wt %, K₂O of 0.03 wt %, CaO of 0.01 wt %, MgO of 0.02 wt %.

95 parts by weight of the Fe/Beta zeolite and 5 parts by weight of zirconium acetate calculated as ZrO₂ were mixed into deionized water to form a slurry. The slurry was milled to a particle size of D₉₀ around 10 μm, as measured with a Sympatec particle size analyser. The milled slurry was coated onto a flow-through cordierite monolith substrate having a diameter of 1 inch, a cell density of 300 cpsi and a wall thickness of 5 mil by dipping the substrate into the slurry. Extra loaded slurry was blown off with an air knife carefully, followed by drying at 130° C. and calcination at 550° C. The process of dipping, drying and calcining was repeated until a total washcoat loading on the substrate of 3.2 g/in³ was obtained.

1.3 Preparation of Test Samples

Two cores having a diameter of 1 inch and a length of 2 inches were cut out from the V-SCR brick and one core having a diameter of 1 inch and a length of 1 inch was cut out from the Fe-zeolite brick. The cores were arranged in the order of first V-SCR core, Fe-zeolite core and second V-SCR core.

### Example 2 Catalytic Article Sample with the Catalyst Arrangement of V-Fe—V

2.1 Preparation of a Brick Comprising V-Based SCR Catalyst on Substrate (V-SCR Brick)

The V-SCR brick was prepared by the same process as described in Example 1.1.

2.2 Preparation of a Brick Comprising Fe-Promoted Molecular Sieve on Substrate (Fe-Zeolite Brick)

A Fe/Beta zeolite from Zeolyst was used, which has a SiO₂ to Al₂O₃ molar ratio of 9, an iron loading of 4.8 wt % calculated as Fe₂O₃, X-ray crystallinity of 98%, BET surface area of 578 m²/g, D₉₀=13 microns, Na₂O of 0.07 wt %, K₂O of 0.03 wt %, CaO of 0.01 wt %, MgO of 0.02 wt %.

90 parts by weight of the Fe/Beta, 5 parts by weight of iron nitrate calculated as Fe₂O₃ and 5 parts by weight of zirconium acetate calculated as ZrO₂ were mixed into deionized water to form a slurry. The slurry was then milled to a particle size of D₉₀ around 10 μm, as measured with a Sympatec particle size analyser. The milled slurry was coated onto a flow-through cordierite monolith substrate having a diameter of 1 inch, a cell density of 300 cpsi and a wall thickness of 5 mil by dipping the substrate into the slurry. Extra loaded slurry was blown off with an air knife carefully, followed by drying at 130° C. and calcination at 550° C. The process of dipping, drying and calcining was repeated until a total washcoat loading on the substrate of 3.2 g/in³ was obtained.

2.3 Preparation of Test Sample

Two cores having a diameter of 1 inch and a length of 2 inches were cut out from the V-SCR brick and one core having a diameter of 1 inch and a length of 1 inch was cut out from the Fe-zeolite brick. The cores were arranged in the order of first V-SCR core, Fe-zeolite core and second V-SCR core.

### Example 3 Catalytic Article Sample with the Catalyst Arrangement of V-Fe—V

A V-SCR brick and a Fe-zeolite brick were prepared by the same processes as described in Examples 1.1 and 1.2 respectively.

Two cores having a diameter of 1 inch and a length of 1.5 inches were cut out from the V-SCR brick and one core having a diameter of 1 inch and a length of 2 inch was cut out from the Fe-zeolite brick. The cores were arranged in the order of first V-SCR core, Fe-zeolite core and second V-SCR core.

### Example 4 Catalytic Article Sample with the Catalyst Arrangement of V—Cu—V

4.1 Preparation of a Brick Comprising V-Based SCR Catalyst on Substrate (V-SCR Brick)

A V-SCR brick was prepared by the same process as described in Example 1.1.

4.2 Preparation of a Brick Comprising Cu-Promoted Molecular Sieve on Substrate (Cu-Zeolite Brick):

A CHA zeolite from Tosoh was used, which has a SiO₂ to Al₂O₃ molar ratio of 16.5, X-ray crystallinity of 99%, BET surface area of 520 m²/g, D₉₀=6 microns, Na₂O<=0.01 wt % and tapped density of 0.7 g/mL.

90 parts by weight of the CHA zeolite, 5 parts by weight of copper oxide CuO and 5 parts by weight of zirconium acetate calculated as ZrO₂ were mixed into deionized water to form a slurry. The slurry was then milled to a particle size of D₉₀ around 5 μm, as measured with a Sympatec particle size analyser. The milled slurry was coated onto a flow-through cordierite monolith substrate having a diameter of 1 inch, a cell density of 300 cpsi and a wall thickness of 5 mil by dipping the substrate into the slurry. Extra loaded slurry was blown off with an air knife carefully, followed by drying at 130° C. and calcination at 550° C. The process of dipping, drying and calcining was repeated until a total washcoat loading on the substrate of 2.1 g/in³ was obtained.

4.3 Preparation of Test Sample

Two cores having a diameter of 1 inch and a length of 2 inches were cut out from the V-SCR brick and one core having a diameter of 1 inch and a length of 1 inch was cut out from the Cu-zeolite brick. The samples were arranged in the order of first V-SCR core, Cu-zeolite core and second V-SCR core.

### Example 5 Catalytic Article Sample with the Catalyst Arrangement of V—Cu—V

5.1 Preparation of a Brick Comprising V-Based SCR Catalyst on Substrate (V-SCR Brick)

The V-SCR brick was prepared by the same process as described in Example 1.1.

5.2 Preparation of a Brick Comprising Cu-Promoted Molecular Sieve on Substrate (Cu-Zeolite Brick)

The Cu-zeolite brick was prepared in accordance with the process as described in Example 4.2, except that an AEI zeolite was used, which is from BASF and has a SiO₂ to Al₂O₃ molar ratio of 21, X-ray crystallinity of 93%, BET surface area of 583 m²/g, D₉₀ of 13 microns, Na₂O<=0.01 wt % and tapped density=0.4 g/mL

5.3 Preparation of Test Sample

Two cores having a diameter of 1 inch and a length of 2 inches were cut out from the V-SCR brick and one core having a diameter of 1 inch and a length of 1 inch was cut out from the Cu-zeolite brick. The cores were arranged in the order of first V-SCR core, Cu-zeolite core and second V-SCR core.

### Example 6 Catalytic Article Sample with the Catalyst Arrangement of V-Fe—Cu—V

A V-SCR brick was prepared by the same process as described in Example 1.1, a Fe-zeolite brick was prepared by the same process as described in Example 1.2, and a Cu-zeolite brick was prepared by the same process as described in Example 4.2.

Two cores having a diameter of 1 inch and a length of 2 inches were cut out from the V-SCR brick, one core having a diameter of 1 inch and a length of 0.5 inch was cut out from the Fe-zeolite brick and one core having a diameter of 1 inch and a length of 0.5 inch was cut out from the Cu-zeolite brick. The cores were arranged in the order of first V-SCR core, Fe-zeolite core, Cu-zeolite core and second V-SCR core such that the first V-SCR core will first contact the test gas.

### Example 7 Catalytic Article Sample with the Catalyst Arrangement of V-Fe—V

A V-SCR brick and a Fe-zeolite brick were prepared by the same processes as described in Example 1.1 and 1.2 respectively.

One core having a diameter of 1 inch and a length of 2.0 inches and one core having a diameter of 1 inch and a length of 2.5 inches were cut out from the V-SCR brick, and one core having a diameter of 1 inch and a length of 0.5 inch was cut out from the Fe-zeolite brick. The cores were arranged in the order of first V-SCR core of 2.0 inches, Fe-zeolite core and second V-SCR core of 2.5 inches such that the first V-SCR core will first contact the test gas.

### Example 8 Catalytic Article with the Catalyst Arrangement of V-Fe—V

The test sample was prepared in the same manner as described in Example 1 except that a Fe/Beta zeolite having a lower Fe₂O₃ loading was used, which is from Zeolyst and has a SiO₂ to Al₂O₃ molar ratio of 41, iron loading of 1.4 wt % calculated as Fe₂O₃, X-ray crystallinity of 100%, BET surface area of 708 m²/g, D₉₀=5 microns, and Na₂O=0.03 wt %.

### Comparative Example 1 Catalytic Article of V-SCR

Three cores having a diameter of 1 inch and a length of 2 inches, 1 inch and 2 inches respectively were cut out from the V-SCR brick as prepared by the same process as described in Example 1.1. The cores were arranged in the order of first V-SCR core of 2 inches, second V-SCR core of 1 inch and third V-SCR core of 2 inches, such that the first V-SCR core will first contact the test gas.

### Comparative Example 2 Catalytic Article with the Catalyst Arrangement of Fe-V-V

The test sample was prepared in the same manner as described in Example 1 except that the cores were arranged in the order of Fe-zeolite core, first V-SCR core and second V-SCR core such that the Fe-zeolite core will first contact the test gas.

### Comparative Example 3 Catalytic Article with the Catalyst Arrangement of V-V-Fe

The test sample was prepared in the same manner as described in Example 1 except that the cores were arranged in the order of first V-SCR core, second V-SCR core and Fe-zeolite core, such that the first V-SCR core will first contact the test gas.

### Comparative Example 4 Catalytic Article with the Catalyst Arrangement of V-Fe—V

The test sample was prepared in the same manner as described in Example 1 except that the two V-SCR cores each had a length of 0.5 inches and the Fe-zeolite core had a length of 4 inches.

### Example 9 SCR Performance Test

### Example 9.1 Test of SCR Performance Under Fluctuation of Temperature and NO₂/NOx Ratio

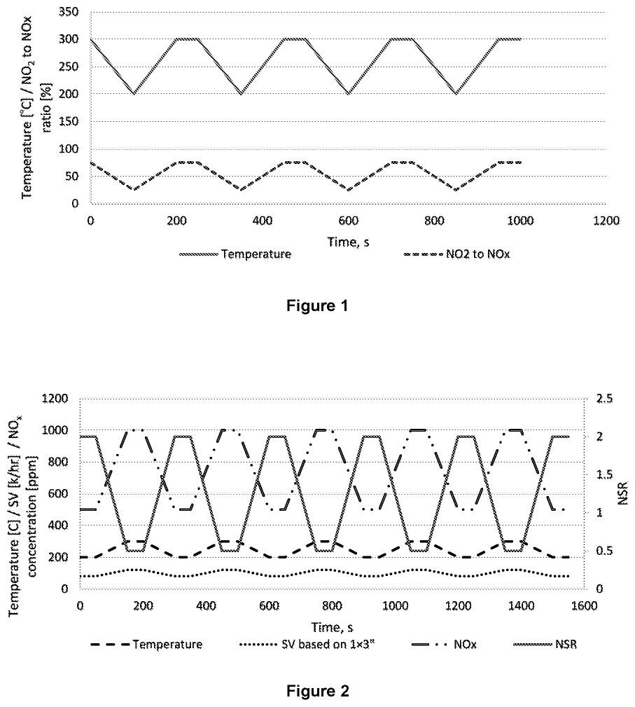

Each sample in fresh state was placed in a laboratory fixed-bed simulator. The base feed gas consists of, by volume, 5% CO₂, 5% H₂O, 10% O₂, 500 ppm NOₓ (NO₂+NO) and the balance of N₂. Space velocity (SV) was fixed at 120,000/hr based on 1″×3″ cylindrical sample. Ratio of NH₃ to NOₓ (NSR) was fixed at 1.2. Temperature and NO₂/NOₓ ratio at the inlet of the laboratory fixed-bed simulator were periodically changed from condition 1 to condition 2 and then back to condition 1 over 200 seconds per cycle (as shown in FIG. 1). In each cycle, condition 1 was maintained for 50 seconds for stabilization. The NO₂/NOₓ ratio was changed by adjusting the NO₂ proportion of the base feed gad, and each test consists of 4 cycles. Accumulative NOx and N₂O emissions after the 4 cycles were measured for the samples and the results were summarized in Table 1 below.
Condition 1: 30000, 75% NO₂ in NOₓ
Condition 2: 20000, 25% NO₂ in NOₓ

TABLE 1

| | | NOx | N₂O |
|---|---|---|---|
| | | emission, | emission, |
| Examples | Designs¹ | g/L_{Cat} | g/L_{Cat} |
| Example 1 | V2-Fe1-V2 | 7.3 | 0.6 |
| | Fe-zeolite region: 4.8 wt % | | |
| | Fe loading², 20 vol % | | |
| Example 2 | V2-Fe1-V2 | 7.4 | 0.5 |
| | Fe-zeolite region: 10.3 wt % | | |
| | Fe loading², 20 vol % | | |
| Example 3 | V1.5-Fe2-V1.5 | 6.6 | 0.8 |
| | Fe-zeolite region: 4.8 wt % | | |
| | Fe loading², 40 vol % | | |
| Example 4 | V2-Cu1-V2 | 7.1 | 0.4 |
| | Cu-CHA region: 5 wt % | | |
| | Cu loading³, 20 vol % | | |
| Comparative | Fe1-V2-V2 | 8.0 | 0.6 |
| Example 2 | Fe-zeolite region: 4.8 wt % | | |
| | Fe loading², 20 vol % | | |
| Comparative | V2-V2-Fe1 | 7.8 | 0.5 |
| Example 3 | Fe-zeolite region: 4.8 wt % | | |
| | Fe loading², 20 vol % | | |
| Comparative | Fe0.5-V4-Fe0.5 | 7.9 | 0.6 |
| Example 4 | Fe-zeolite region: 4.8 wt % | | |
| | Fe loading², 20 vol % | | |

¹In each schematic sample design, “V” and “Fe” represent V-SCR core and Fe-zeolite core respectively and the accompanied numbers represent the core lengths in inch
²The Fe loading is calculated as Fe₂O₃ based on the total weight of the Fe-zeolite
³The Cu loading is calculated as CuO based on the total weight of the Cu-zeolite

Surprisingly, as can be seen from the test results in Table 1, the SCR catalytic samples including a metal-promoted zeolite region located between two vanadium-based SCR regions according to the invention show an improvement of NOx abatement, i.e., lower NOx emission, compared with the SCR catalytic sample having the catalyst arrangements different from the inventive arrangement design.

Particularly, the comparison between the SCR catalytic sample of Example 1 and those of comparative Examples 2 and 3 clearly shows the improvement of NOx abatement achieved by the inventive arrangement design of the vanadium-based SCR catalyst and the metal-promoted zeolite catalyst while no increase of N₂O formation was observed.

### Example 9.2 Test of SCR Performance Under Fluctuation of Temperature, NOx Feeding, NH₃/NOx Ratio, and Space Velocity

Each sample in fresh state was placed in a laboratory fixed-bed simulator. The base feed gas consists of, by volume, 5% CO₂, 5% H₂O, 10% O₂, NOₓ (NO₂+NO) and the balance of N₂. Temperature, space velocity (SV), NOₓ feeding and NH₃/NOₓ ratio (NSR) at the inlet of the laboratory fixed-bed simulator were periodically changed from condition 1 to condition 2 and then back to condition 1 (as shown in FIG. 2). In each cycle, the change from one condition to the other is accomplished over 100 seconds, and the condition 1 and condition 2 were both maintained for 50 seconds for stabilization. Each test consists of 5 cycles. The NOₓ conversion calculated based on the accumulative emission and the accumulative N₂O emission after the 5 cycles were measured for the samples and the results were summarized in Table 2 below.
Condition 1: 200° C., SV=80,000/hr, NOₓ=500 ppm, NSR=2, 50% NO₂ in NOₓ
Condition 2: 300° C., SV=120,000/hr, NOₓ=1000 ppm, NSR=0.5, 50% NO₂ in NOₓ

TABLE 2

| | | NOx | N₂O |
|---|---|---|---|
| | | conversion, | emission, |
| Examples | Designs¹ | % | g/L_{Cat} |
| Example 1 | V2-Fe1-V2 | 73.2 | 0.2 |
| | Fe-zeolite region: 4.8 wt % | | |
| | Fe loading², 20 vol % | | |
| Example 2 | V2-Fe1-V2 | 74.6 | 0.2 |
| | Fe-zeolite region: 10.3 wt % | | |
| | Fe loading², 20 vol % | | |
| Example 3 | V1.5-Fe2-V1.5 | 78.2 | 0.2 |
| | Fe-zeolite region: 4.8 wt % | | |
| | Fe loading², 40 vol % | | |
| Example 4 | V2-Cu1-V2 | 76.6 | 0.3 |
| | Cu-CHA region: 5 wt % | | |
| | Cu loading³, 20 vol % | | |
| Example 5 | V2-Cu1-V2 | 71.7 | 0.3 |
| | Cu-AEI region: 5 wt % | | |
| | Cu loading³, 20 vol % | | |
| Example 6 | V2-Fe0.5-Cu0.5-V2 | 74.1 | 0.3 |
| | Fe-zeolite region: 4.8 wt % | | |
| | Fe loading², 10 vol % | | |
| | Cu-CHA region: 5 wt % | | |
| | Cu loading³, 10 vol % | | |
| Example 7 | V2-Fe0.5-V2.5 | 70.2 | 0.2 |
| | Fe-zeolite region: 4.8 wt % | | |
| | Fe loading², 10 vol % | | |
| Example 8 | V2-Fe1-V2 | 70.7 | 0.2 |
| | Fe-zeolite region: 1.4 wt % | | |
| | Fe loading², 20 vol % | | |
| Comparative | V-V-V | 66.4 | 0.2 |
| Example 1 | | | |
| Comparative | Fe1-V2-V2 | 69.4 | 0.3 |
| Example 2 | Fe-zeolite region: 4.8 wt % | | |
| | Fe loading², 20 vol % | | |

¹In each schematic sample design, “V”, “Fe” and “Cu” represent V-SCR core, Fe-zeolite core and Cu-zeolite core respectively and the accompanied numbers represent the core lengths in inch
²The Fe loading is calculated as Fe₂O₃ based on the total weight of the Fe-zeolite
³The Cu loading is calculated as CuO based on the total weight of the Cu-zeolite

It can be found that the improvement of the NOₓ abatement resulted from the inventive catalyst design can also be achieved even under a complicated fluctuation of multiple conditions while no increase of N₂O formation was observed.

1. A catalytic article for purifying an exhaust gas containing nitrogen oxides, which comprises
a first region containing a vanadium-based SCR catalyst,
a second region containing a metal-promoted molecular sieve catalyst, and
a third region containing a vanadium-based SCR catalyst,
wherein
at least part of the second region is located downstream of at least part of the first region and upstream of at least part of the third region in the exhaust gas flow direction,
provided that no part of the second region is located upstream of the first region or downstream of the third region.

2. The catalytic article according to claim 1, wherein the vanadium-based SCR catalyst in each of the first region and the third region contains a vanadium oxide and optionally at least one oxide of another element as a promoter, which are supported on particles of support.

3. The catalytic article according to claim 2, wherein the other element as a promoter is selected from the group consisting of B, Al, Bi, Si, Sn, Pb, Sb, Cr, Mn, Fe, Co, Ni, Cu, Zn, Ga, Ce, Y, Nb, Mo and W.

4. The catalytic article according to claim 2, wherein the support is selected from molecular sieve and one or more oxides of an element selected from the group consisting of Ti, Si, W, Al, Ce, Zr, Mg, Ca, Ba, Y, La, Pr, Nb, Mo, Mn, Fe, Co, Ni, Cu, Zn, Ga, Sn and Bi.

5. The catalytic article according to claim 1, wherein the vanadium-based SCR catalysts in the first region and the third region contain vanadium, calculated as V₂O₅, in an amount of 0.1 to 20% by weight, 1 to 15% by weight, 2 to 10% by weight, or 2 to 7% by weight, based on the total weight of the vanadium-based SCR catalyst, and wherein the vanadium contents of the vanadium-based SCR catalysts in the two regions are same or different.

6. The catalytic article according to claim 1, wherein the molecular sieve in the metal-promoted molecular sieve catalyst is selected from zeolites having a framework type of ABW, ACO, AEI, AEL, AEN, AET, AFG, AFI, AFN, AFO, AFR, AFS, AFT, AFV, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEI, EMT, EON, EPI, ERI, ESV, ETR, EUO, *-EWT, EZT, FAR, FAU, FER, FRA, GIS, GIU, GME, GON, GOO, HEU, IFO, IFR, -IFU, IFW, IFY, IHW, IMF, IRN, IRR, -IRY, ISV, ITE, ITG, ITH, *-ITN, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, *MRE, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POS, PSI, PUN, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, *SFV, SFW, SGT, SIV, SOD, SOF, SOS, SSF, *-SSO, SSY, STF, STI, *STO, STT, STW, -SVR, SVV, SZR, TER, THO, TOL, TON, TSC, TUN, UEI, UFI, UOS, UOV, UOZ, USI, UTL, UWY, VET, VFI, VNI, VSV, WEI, -WEN, YUG or ZON, and any combinations thereof, among which AEI, BEA, CHA, AFT, AFX, FAU, FER, KFI, MOR, MFI, MOR, MEL or any combinations thereof are preferred.

7. The catalytic article according to claim 1, wherein the metal for promoting the molecular sieve in the second region is selected from precious metals such as Au and Ag, platinum group metals such as Ru, Rh, Pd, In and Pt, base metals such as Cr, Zr, Nb, Mo, Fe, Mn, W, V, Ti, Co, Ni, Cu, Zn, Sb, Sn and Bi, alkali earth metals such as Ca and Mg, and any combinations thereof.

8. The catalytic article according to claim 7, wherein the metal for promoting the molecular sieve in the second region is Fe, Cu or a combination thereof.

9. The catalytic article according to claim 1, wherein the metal for promoting the molecular sieve in the second region is present in the metal-promoted molecular sieve catalyst at an amount of in the range of 0.1 to 20% by weight, 0.5 to 15% by weight or 1 to 10% by weight on an oxide basis, based on the total weight of the metal-promoted molecular sieve.

10. The catalytic article according to claim 1, wherein the first region, the second region and the third region are, independently from each other, present in form of an extrudate or in form of a washcoat on a substrate.

11. The catalytic article according to claim 10, wherein the extrudate and/or the substrate have a honeycomb structure, for example monolithic flow-through structure or wall-flow structure.

12. The catalytic article according to claim 1, wherein the first, second and third regions are carried on two or more pieces of inert substrate separately.

13. The catalytic article according to claim 1, wherein the second region is comprised in the catalytic article in a proportion of 0.5 to 80% by volume, preferably 1 to 75% by volume, more preferably 5 to 65% by volume, for example 10 to 60% by volume or 15 to 50% by volume, relative to the total volume of the catalytic article.

14. The catalytic article according to claim 1, wherein the first and third regions are, independently from each other, comprised in the catalytic article in a proportion of 10 to 60% by volume, preferably 15 to 55% by volume, more preferably 25 to 50% by volume, relative to the total volume of the catalytic article.

15. The catalytic article according to claim 1, which comprises
a first region containing a vanadium-based SCR catalyst,
a second region containing a metal-promoted molecular sieve catalyst, and
a third region containing a vanadium-based SCR catalyst,
wherein the second region is located downstream of at least part of the first region and upstream of at least part of the third region.

16. The catalytic article according to claim 15, which comprises
a first region containing a vanadium-based SCR catalyst,
a second region containing a metal-promoted molecular sieve catalyst, and
a third region containing a vanadium-based SCR catalyst,
wherein the second region is located totally downstream of the first region and totally upstream of the third region.

17. A method for treatment of an exhaust gas containing nitrogen oxides, which comprises contacting the exhaust gas with the catalytic article as defined in claim 1 in the presence of a reductant.

18. The method according to claim 17, wherein the exhaust gas originates from internal combustion engines, for example gasoline or Diesel engines.

19. A system for treatment of an exhaust gas, especially originating from an internal combustion engine, which comprises a reductant source, the catalytic article according to claim 1, and optionally one or more of diesel oxidation catalyst (DOC), three-way conversion catalyst (TWC), four-way conversion catalyst (FWC), non-catalyzed or catalyzed soot filter (CSF), ammonia oxidation catalyst (AMOx), NOx trap, NOx absorber catalyst, hydrocarbon trap catalyst, sensor and mixer.
